(19) United States
(12) Patent Application Publication
(10) Pub. No.: US 2022/0393562 A1
(43) Pub. Date: Dec. 8, 2022

(54) THREE-PHASE FOUR-WIRE BI-DIRECTIONAL SWITCHING CIRCUIT FOR AN ELECTRIC VEHICLE

(71) Applicant: BORGWARNER, INC., Auburn Hills, MI (US)

(72) Inventors: Luca DI CARLO, Teramo (IT); Ali BAHRAMI, Ravenna (IT)

(21) Appl. No.: 17/755,032

(22) PCT Filed: Oct. 24, 2019
(86) PCT No.: PCT/US2019/057799

§ 371 Date: Apr. 19, 2022

(51) Int. Cl. H02M 1/00; B60L 53/24

(52) U.S. Cl. CPC H02M 1/007; B60L 53/24

(57) ABSTRACT

A switching circuit for an electric vehicle (EV) includes a first leg of the switching circuit, including a first switch and a second switch, that receives a first phase of three-phase alternating current (AC) electrical power; a second leg of the switching circuit, including a first switch and a second switch, that receives a second phase of three-phase AC electrical power; a third leg of the switching circuit, including a first switch and a second switch, that receives a third phase of three-phase AC electrical power; and a capacitor leg having two or more capacitors electrically connected in parallel with the first leg, the second leg, the third leg of the switching circuit, wherein the capacitor(s) permit zero sequence current flow through the first leg, the second leg, and the third leg while the three-phase AC electrical power is applied to the circuit.

### TECHNICAL FIELD

The present application relates to electrical circuits and, more particularly, to electrical circuits used with electrically-propelled vehicles.

### BACKGROUND

Electrical systems in vehicles powered by internal combustion engines (ICEs) have typically used a battery to facilitate ignition and provide electrical power to vehicle accessories. A level of battery charge may be maintained by an alternator that is mechanically coupled to an output of the ICE. As the ICE operates, the output turns a rotor of the alternator thereby inducing the flow of current through windings in a stator. Passive electrical components are implemented as voltage regulators to apply the alternating current (AC) generated by the alternator to the direct current (DC) vehicle electrical system and battery.

Modern vehicles are increasingly propelled by one or more electrical motors powered by higher-voltage batteries. These vehicles are often referred to as electric vehicles (EV) or hybrid-electric vehicles (HEV) and include an on-board vehicle battery charger for charging the batteries that power the electrical motors. These batteries may have a significantly higher voltage than those used with vehicles not powered by electrical motors. Unlike batteries used with vehicles solely powered by an ICE, the on-board vehicle battery charger regulates incoming AC electrical power received by the EV from EV service equipment, such as a charging station, fixed to a residence or a particular geographic location. And in addition to the incoming AC electrical power from the EV service equipment to the on-board vehicle charger, modern vehicles are increasingly able to return electrical power stored in vehicle batteries to the electrical grid as well as to local consumers.

### SUMMARY

In one implementation, a switching circuit for an electric vehicle (EV) includes a first leg of the switching circuit, having a first switch and a second switch, that receives a first phase of three-phase alternating current (AC) electrical power; a second leg of the switching circuit, including a first switch and a second switch, that receives a second phase of three-phase AC electrical power; a third leg of the switching circuit, including a first switch and a second switch, that receives a third phase of three-phase AC electrical power; and a capacitor leg having two or more capacitors electrically connected in parallel with the first leg, the second leg, the third leg of the switching circuit, wherein the capacitor(s) permit zero sequence current flow through the first leg, the second leg, and the third leg while the three-phase AC electrical power is applied to the circuit.

In another implementation, a switching circuit for an EV includes a first leg of the switching circuit, having a first switch and a second switch, that receives a first phase of three-phase alternating current (AC) electrical power; a second leg of the switching circuit, including a first switch and a second switch, that receives a second phase of three-phase AC electrical power; a third leg of the switching circuit, including a first switch and a second switch, that receives a third phase of three-phase AC electrical power; a neutral leg including a first switch and a second switch, that permit zero sequence current flow through the first leg, the second leg, and the third leg while the three-phase AC electrical power is applied to the circuit; and a capacitor leg having one or more capacitors electrically connected in parallel with the first leg, the second leg, the third leg of the switching circuit

In yet another implementation, a switching circuit for an EV includes a first leg of the switching circuit, having a first switch and a second switch, that receives a first phase of three-phase alternating current (AC) electrical power; a second leg of the switching circuit, including a first switch and a second switch, that receives a second phase of three-phase AC electrical power; a third leg of the switching circuit, including a first switch and a second switch, that receives a third phase of three-phase AC electrical power; a neutral leg including a first switch and a second switch; and a capacitor leg including two or more capacitors electrically connected to the first leg, the second leg, the third leg, and the neutral leg of the switching circuit in series and electrically connected at a midpoint to the neutral leg, wherein the capacitors permit zero sequence current flow through the first leg, the second leg, or the third leg while the three-phase AC electrical power is applied to the circuit.

### BRIEF DESCRIPTION OF THE DRAWINGS

FIG. 1 is a block diagram depicting an electrical system that includes an implementation of a switching circuit;

FIG. 2 is a circuit diagram depicting an implementation of a switching circuit;

FIG. 3 is a circuit diagram depicting another implementation of a switching circuit;

FIG. 4 is a circuit diagram depicting another implementation of a switching circuit;

FIG. 5 is a block diagram depicting an implementation of control system that can be used with a switching circuit;

FIG. 6 is a block diagram depicting an implementation of a portion of a control system that can be used with a switching circuit;

FIG. 7 is a block diagram depicting another implementation of a portion of a control system that can be used with a switching circuit;

FIG. 8 is a block diagram depicting another implementation of a portion of a control system that can be used with a switching circuit; and

FIG. 9 is a block diagram depicting another implementation of a portion of a control system that can be used with a switching circuit.

### DETAILED DESCRIPTION

An on-board vehicle battery charger (OBC) carried by an electric vehicle (EV) can at least partially regulate an alternating current (AC) input using a switching circuit having a plurality of active electrical components at three legs, as well as a neutral leg that can use capacitors to passively affect current or a plurality of active electrical components that actively affect current. The active electrical components on each of the three legs can act as rectifiers as EV service equipment supplies AC electrical power to the EV or as the EV supplies AC electrical power to the grid. More specifically, the switching circuit can be described as a three-phase four-wire AC/DC inverter. Previous vehicle electrical systems have included a diode electrically linked to a neutral leg of a four-wire AC/DC inverter to help balance the load at each phase of three phase AC electrical power. However, during periods of significantly unbalanced electrical loads over the three legs, or during conditions under which the AC electrical power through one of the legs is intended to be zero, the diode bridge may not sufficiently control the flow of current through the phases.

In contrast, a switching circuit used at a power factor correction (PFC) module of the OBC can include capacitance, such as cascaded capacitors, and/or a plurality of active electrical components electrically connected to the neutral leg to regulate a bi-directional flow of AC electrical power either from an electrical grid to the on-board vehicle battery charger or from the vehicle battery to the electrical grid such that the flow of electrical current on one or more legs can be zero. This can help regulate the flow of electrical current through each leg when the amount of current at each leg is different. These conditions can exist when AC electrical power is supplied from the vehicle-to-the-grid (V2G) and the current draw at each leg is different, a geographically-fixed electrical meter, such as a “smart meter,” receiving AC electrical power from the vehicle permits different current values at each leg, or the on-board vehicle battery charger permits different current amounts at each leg, to identify a few applications.

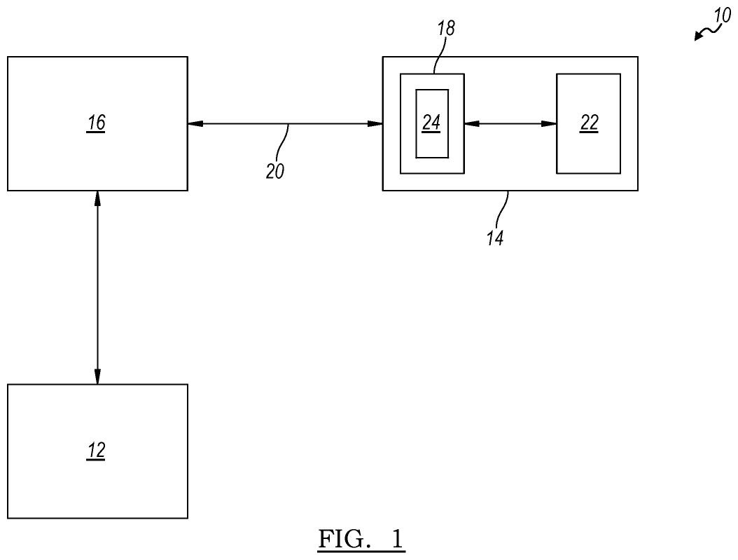

Turning to FIG. 1, an implementation of an electrical system 10 is shown including an electrical grid 12 and an electric vehicle (EV) 14 that can either receive electrical power from or provide electrical power to the grid 12. The electrical grid 12 can include any one of a number of electrical power generators and electrical delivery mechanisms. Electrical generators (not shown), such as nuclear, hydraulic-, or wind-powered plants that convert the energy of nuclear fission, flow of water through dams, or wind power of a turbine, create AC electrical power that can then be transmitted a significant distance away from the electrical generator for residential and commercial use. The electrical generator can couple with the electrical grid 12 that transmits the AC electrical power from the electrical generator to an end user, such as a residence or business. As the AC electrical power is provided to the electrical grid 12, the electrical power can exist at a relatively high voltage so that it can be communicated relatively long distances. Once the electrical power reaches a location where it is intended to be used, electrical transformers (not shown) can be used to reduce the voltage level before ultimately being provided to a residence or business. In one implementation, the voltage level of AC electrical power received by the residence or business is 240 volts (V). However, this voltage can be a different value.

EV service equipment 16, also referred to as an electric-vehicle-charging station, can receive AC electrical power from the grid 12 and provide the electrical power to the EV 14. Also, the EV service equipment 16 can receive stored electrical power from a vehicle battery 22 that has been converted from DC to AC electrical power and transfer it to the grid 12. The charging station 16 can be geographically fixed, such as a charging station located in a vehicle garage or in a vehicle parking lot. The charging station 16 can include an input terminal that receives the AC electrical power from the grid 12 and communicates the AC electrical power to an on-board vehicle battery charger 18 included on the EV 14. An electrical cable 20 can detachably connect with an electrical receptacle on the EV 14 and electrically link the charging station 16 with the EV 14 so that AC electrical power can be communicated between the charging station 16 and the EV 14. The charging station 16 can be classified as “Level 2” EV service equipment that receives 240 VAC from the grid 12 and supplies 240 VAC to the EV 14. One implementation of the charging station 16 is a Siemens VersiCharge™ Residential EV Charging Solution. It is possible the level of AC electrical power input to a charging station and/or the level of AC electrical power output from a charging station is different in other implementations. The term “EV” can refer to vehicles that are propelled, either wholly or partially, by electric motors. EV can refer to electric vehicles, plug-in electric vehicles, hybrid-electric vehicles, and battery-powered vehicles. The vehicle battery 22 can supply DC electrical power, that has been converted from AC electrical power, to the electric motors that propel the EV. The vehicle battery 22 or batteries are rechargeable and can include lead-acid batteries, nickel cadmium (NiCd), nickel metal hydride, lithium-ion, and lithium polymer batteries. A typical range of vehicle battery voltages can range from 200 to 800V of DC electrical power (VDC).

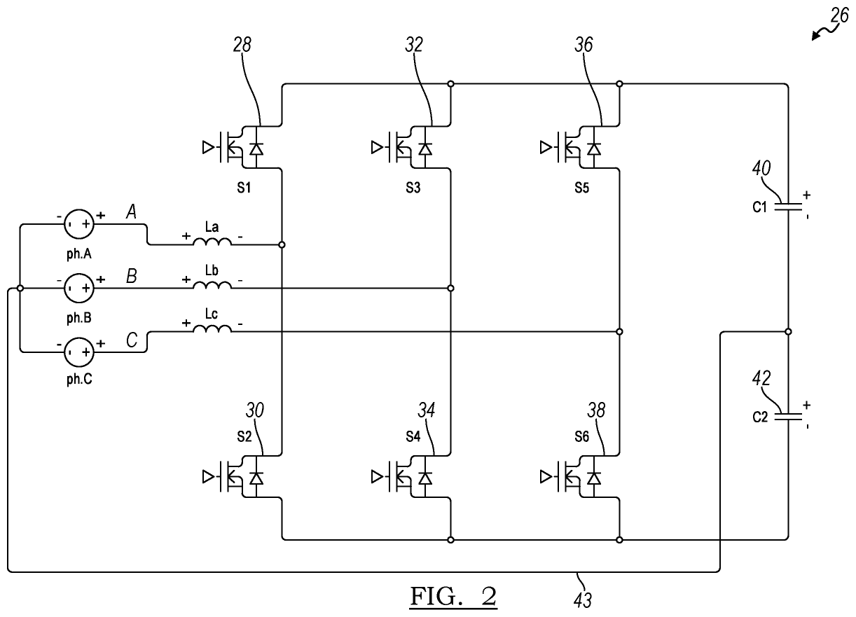

The on-board vehicle battery charger 18 can be electrically connected to the EV service equipment 16 and communicate electrical power between the vehicle battery 22 and the EV service equipment 16. AC electrical power received from the grid 12 can be converted to DC by the on-board vehicle battery charger 18 that may be located on the EV 14. The on-board vehicle battery charger 18 can include a power factor correction (PFC) module 24 having a switching circuit 26 that converts AC electrical power into DC electrical power as is shown in FIG. 2. In addition, the switching circuit 26 can also act as an inverter that converts DC electrical power into AC electrical power, which can be transmitted outside of the EV 14. The switching circuit 26 can include two actively controlled switches for each phase or leg of an AC circuit (A, B, and C). The actively controlled switches can serve as active rectifiers for incoming AC electrical power. In addition, the switches can work as inverters for converting DC electrical power stored in the vehicle battery 22 into AC electrical power that can be transmitted outside of the EV 14. The first leg (A) includes a first switch 28 and a second switch 30, the second leg (B) includes a first switch 32 and a second switch 34, and the third leg (C) includes a first switch 36 and a second switch 38. The first leg (A) is electrically connected to the source of the first switch 28 and the drain of the second switch 30. The second leg (B) is electrically connected to the source of the first switch 32 and the drain of the second switch 34. The third leg (C) is electrically connected to the source of the first switch 36 and the drain of the second switch (38). The switches included in the switching circuit 26 can be implemented using field effect transistors (FETs), such as metal-oxide-semiconductor field effect transistors (MOSFETs). A microprocessor (not shown) electrically linked to the gate of each switch can control the rectification of incoming AC electrical power as well as the inversion of outgoing DC electrical power. The switches can be wired in parallel with bulk capacitors and a load (not shown), such as the vehicle battery 22.

In this implementation, a first capacitor 40 is electrically connected to the drain of the first switch 36 of the third leg (C) and a second capacitor 42 is electrically connected to a source of the second switch 38 of the third leg (C). As AC electrical power is received from the grid 12, each phase of the AC electrical power can be regulated by the coordinated application of voltage to the gate of the first and second switches to rectify AC electrical power into DC electrical power. The switching circuit 26 includes a capacitor leg 43 that is electrically connected to a midpoint of the bulk capacitors 40, 42 and the vehicle battery 22 that can be wired in parallel with the bulk capacitors 40, 42. The capacitor leg 43 can conduct neutral current from the capacitors 40, 42. The flow of current through the capacitor leg 43 can be passively controlled by the capacitors 40, 42. The first capacitor 40 can be electrically connected to the drain of the first switch 36 of the third leg (C) and the second capacitor 42 can be electrically connected to the source of the second switch 38 of the third leg. The bulk capacitors 40, 42 can be a pair of capacitors wired to each other in series relative to each other. The switching circuit 26 can be used with a control system implementing a synchronous reference frame strategy. As the switches 28, 30, 32, 34, 36, 38 are selectively opened and closed to invert incoming AC electrical power, the control system can by synchronized based on a reference that rotates at a synchronous speed (angular speed) corresponding to the frequency of the AC electrical power. Control systems that implement the synchronous reference frame strategy can reduce the complexity of the control system so that PI controllers can be used to regulate DC voltage rather than AC voltage.

If different current levels flow through each of the legs (A, B, C), a zero-sequence current can exist on the capacitor leg 43 during the unbalanced state. Typically, when current levels on each leg are balanced, a positive-sequence current can exist on the neutral leg 43. It should also be appreciated that the switching circuit 26 is bidirectional such that the circuit 26 can also act as an inverter permitting DC electrical energy stored in the vehicle battery 22 to be converted to AC electrical power and communicated to the electrical grid 12. A synchronous reference frame control of incoming three-phase AC electrical power can be used to control the circuit 26 so as to regulate DC values (through D and Q components) rather than AC values, which can yield a zero steady state error. This is discussed in more detail below with respect to the implementations of control systems.

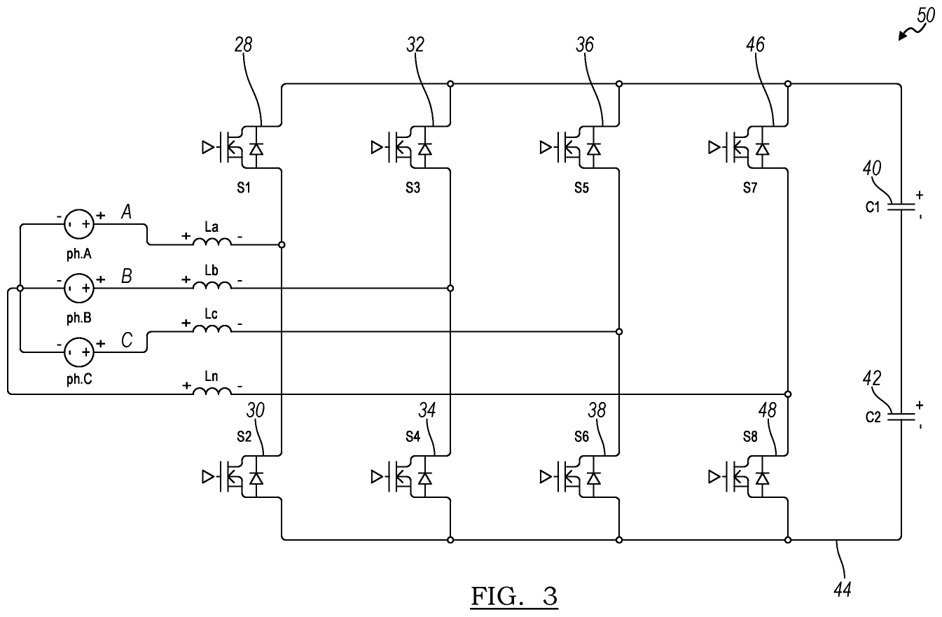

Turning to FIG. 3, another implementation of a switching circuit 50 is shown. The switching circuit 50 includes two actively controlled switches 28, 30, 32, 34, 36, 38 for each leg of an AC circuit as well as two actively controlled switches 46, 48 for a neutral leg 44 of the AC circuit resulting in a circuit that includes eight switches. The neutral leg 44 can be wired to a midpoint of the switches 46, 48 electrically connected to the neutral leg 44. The actively controlled switches can serve as active rectifiers for incoming AC electrical power. The first leg (A) includes the first switch 28 and the second switch 30, the second leg (B) includes the first switch 32 and the second switch 34, and the third leg (C) includes the first switch 36 and the second switch 38. The first leg (A) is electrically connected to the source of the first switch 28 and the drain of the second switch 30. The second leg (B) is electrically connected to the source of the first switch 32 and the drain of the second switch 34. The third leg (C) is electrically connected to the source of the first switch 36 and the drain of the second switch 38. A first switch 46 of the neutral leg 44 is electrically connected to the neutral leg 44 at the source and a second switch 48 of the neutral leg 44 is connected to the neutral leg 44 at the drain. The switches included in the switching circuit can be implemented as described above using FETs, such as MOSFETs. A microprocessor (not shown) can electrically link to the gate of each switch controlling the rectification of incoming AC electrical power. The switches can be wired in parallel with bulk capacitors and a load, such as the vehicle battery 22.

In this implementation, the first capacitor 40 is electrically connected to the drain of the first switch 46 of the neutral leg 44 and a second capacitor 42 is electrically connected to a source of the second switch 48 of the neutral leg 44. The first and second capacitors 40, 42 can be electrically connected to each other in series. As AC electrical power is received from the grid 12, each phase of the AC electrical power is regulated by the coordinated application of voltage to the gate of the first and second switches to rectify AC electrical power into DC electrical power. In this implementation, an inductor 52 can be electrically connected to the source of the first switch 46 of the neutral leg 44 and the drain of the second switch 48 of the neutral leg 44. The inductor 52 can permit seven levels of converter voltage with respect to the neutral leg 44 that may result in lower total harmonic distortion (THD) of current when the switching circuit 50 is used to adjust the power factor and lower THD of voltage when inverting mode is used to provide power to a location outside of the EV 14, such as the electrical grid 12. In an implementation in which the three-phase AC electrical power is rated for 11 kilowatts (kW), the inductor 52 can also be rated for 16 ampere (A) permitting the switching circuit 50 to have a 32A rating for single phase operation using an interleaved approach of two of the legs. However, it is possible to implement the switching circuit 50 without including the inductor 52.

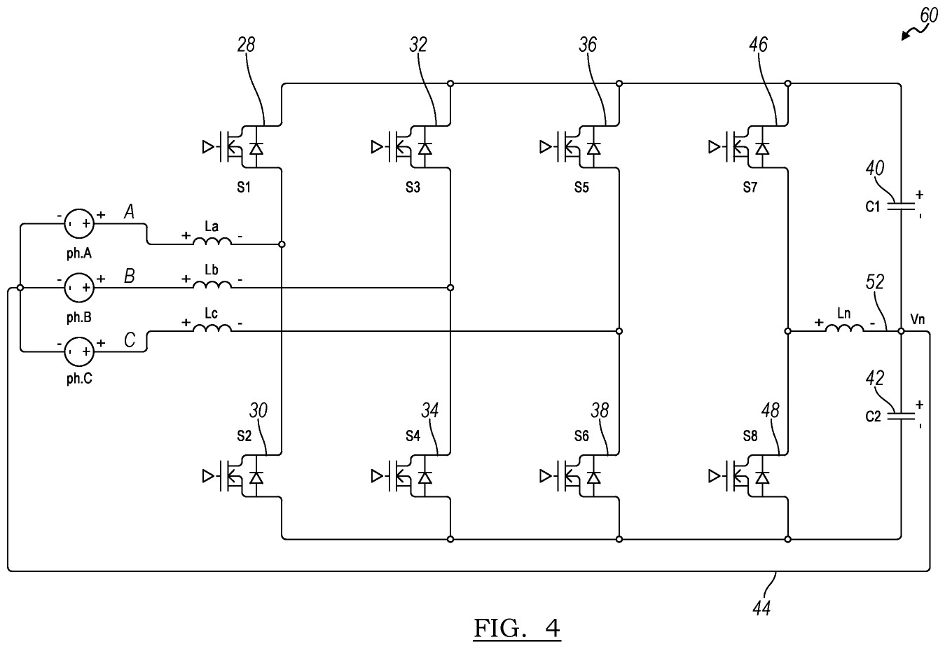

In FIG. 4, another implementation of a switching circuit 60 is shown. The switching circuit 60 is similar to the switching circuit 50 shown in FIG. 3 and described above. The switching circuit 60 includes two actively controlled switches 28, 30, 32, 34, 36, 38 for each leg of an AC circuit as well as two actively controlled switches 46,48 for the neutral leg 44 of the AC circuit. In this implementation, the neutral leg 44 can be electrically connected to a midpoint of first and second capacitors 40, 42 at a node that also is electrically connected to the inductor 52. The actively controlled switches can serve as active rectifiers for incoming AC electrical power. The first leg (A) includes the first switch 28 and the second switch 30, the second leg (B) includes a first switch 32 and the second switch 34, and the third leg (C) includes the first switch 36 and the second switch 38. The first switch 46 of the neutral leg 44 is electrically connected to the neutral leg 44 at the source through the inductor 52 and the second switch 48 of the neutral leg 44 is connected to the neutral leg 44 through the inductor 52 at the drain. The drain of the first switch 46 of the neutral leg 44 is electrically connected to the first capacitor 40 and the source of the second switch 48 of the neutral leg 44 is electrically connected to the second capacitor 42. This electrical connection of the inductor 52 to the mid-point of the neutral leg 44 and the capacitors 40, 42 can create a synchronous buck converter.

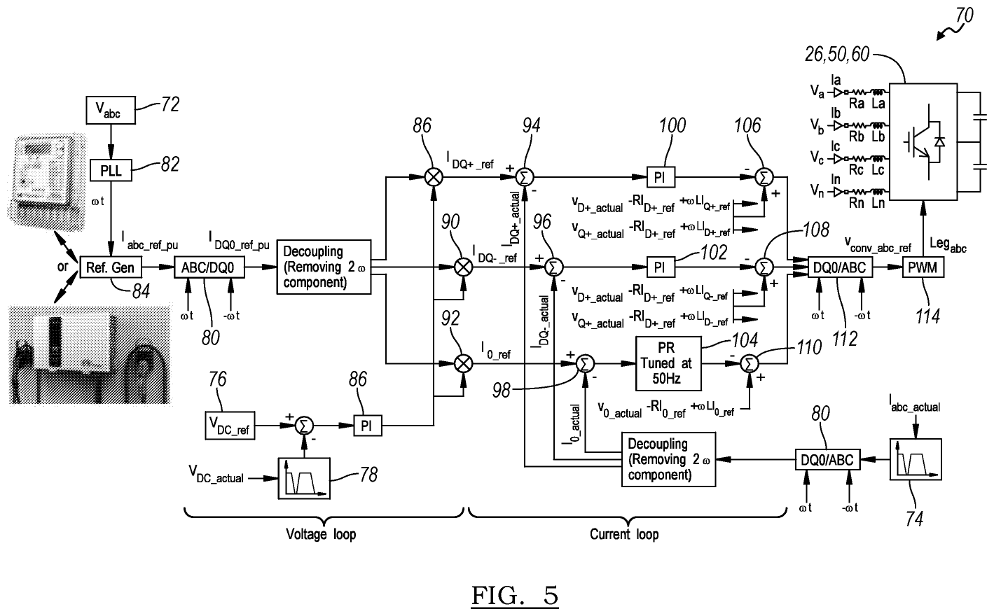

An implementation of a control system 70 for controlling the switches included in a switching circuits 26, 50, 60 is shown in FIG. 5. This implementation provides for independent control of direct, quadrature, and zero components in synchronous reference frame control of incoming three-phase AC electrical power. The control system 70 can be used with the switching circuits 26, 50, 60 disclosed above. The control system 70 can receive inputs that include a voltage level 72 of the three-phase AC electrical power, such as can be sensed from the AC electrical power received from the grid 12 at the EV 14, the current level 74 of the three-phase electrical power, a DC reference voltage 76, and an actual DC voltage level 78, such as could be sensed from the vehicle battery 22. The control system 70 can use a Park-Clark transformation 80 to convert AC waveforms to DC signals (DQ0) to implement synchronous reference frame control. The transformation of each phase of incoming three-phase AC electrical power can be represented by the transformed components, including components D and Q in a positive direction (DQ+), D and Q in a negative direction (DQ−), as well as a zero component (0). Separate transformations of both the voltage and the current of the AC electrical power can occur. The control system 70 can receive an incoming voltage of the three-phase AC electrical power at a phase-locked loop (PLL) 82 that outputs a signal having the angle of each phase voltage. The output of the PLL can be used to produce the reference signal created by reference generator block 84 and then transformed with the Park-Clark transformation 80 into the DQ+, DQ−, and 0 components. The reference generator block 84 can receive a voltage input from any one of a variety of inputs, such as a smart electricity meter that can be associated with a house or office, or electric vehicle supply equipment (EVSE) like the EV service equipment 16. The DC voltage reference signal 76 and the actual DC voltage 78, such as from the vehicle battery 22, can be compared and provided to a DC voltage proportional integrator (PI) controller 86.

The output of the PI controller 86 can then be provided to a DQ+ multiplier 88, a DQ− multiplier 90, and a zero multiplier 92, which each multiply the output of the controller 86 with the transformed and decoupled components DQ+, DQ−, and 0. The actual current value 74 from the three-phase AC electrical power can be measured and transformed using the Park-Clarke transformation 80 and then decoupled; the transformed and decoupled components can be provided to an IDQ+ comparator 94, an IDQ− comparator 96, and an I0 comparator 98, each of which can also receive the other input from the DQ+ multiplier 88, a DQ− multiplier 90, and the DQ0 multiplier 92. Decoupling can involve removing a 2ω component from the signal. The output from the IDQ+ summer 94 is provided to an IDQ+ PI controller 100, the output from the IDQ− summer 96 is provided to an IDQ− PI controller 102, and the output from the I0 summer 98 is provided to an I0 proportional resonant (PR) controller 104. In one implementation, the PR controller can be tuned to 50 hertz (hz). Output from the IDQ+ PI controller 100, the IDQ− PI controller 102, and the I0 PR controller is provided to a first summer 106, a second summer 108, and a PR summer 110, respectively. The first PI summer 106, the second PI summer 108, and the summer 110 each also receive the other input from feed forward signals that can be calculated from dynamic equation. The output from each of the first summer 106, the second summer 108, and the summer 110 are converted back into an A, B, C reference frame using inverse Park-Clark transformation 112 and used to provide references to the pulse width modulation (PWM) block 114 to control the switches of the switching circuits with PWM signals.

A plurality of different control strategies can be used to control the neutral leg 44 of the switching circuits described above. For example, these control strategies can include dependent PWM control, an independently fixed 50% duty cycle control, dependent neutral control, and an independent mid-point voltage control. The independent mid-point voltage control in particular can be used with the switching circuit 60.

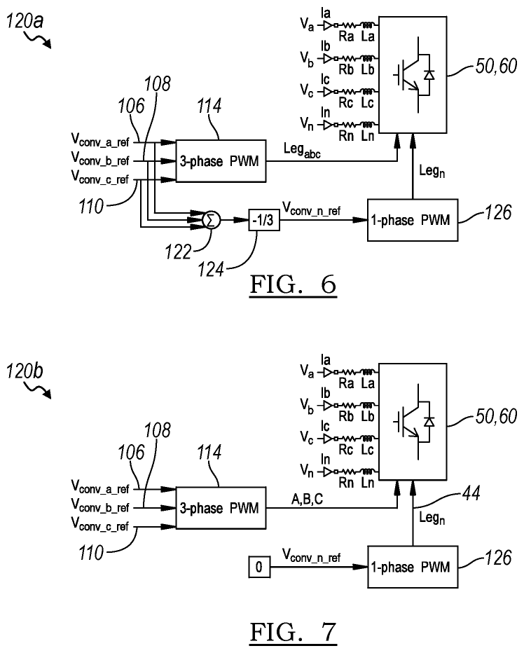

The control system 70 described above and depicted in FIG. 5 can work along with a dependent PWM control system 120a depicted in FIG. 6 that controls the neutral leg 44 of the switching circuits shown in FIGS. 3-4. With respect to the switching circuits 50, 60 shown in FIGS. 3-4, control of the neutral leg 44 can depend on the control of the other three phases. The neutral control system 120a can control the neutral leg 44 independent from the other three phases. The output from the first summer 106, the second summer 108, and the summer 110 can be added by a neutral summer and then averaged by dividing by one-third at a divider 124, communicated to a one-phase PWM module 126 and then used to control the neutral leg 44. The reference value of the neutral leg 44—or output from the divider 124—can be calculated by averaging the voltage reference from the first leg (A), the second leg (B), and the third leg (C).

An implementation of an independent fixed 50% duty cycle control system 120b is shown in FIG. 7. The control system 120b includes some blocks that have been described above. However, the control system 120b receives a zero-voltage value at the one-phase PWM module 126. In such an implementation, the duty cycle of switches 46, 48 of the neutral leg 44 can equal 50%. This configuration may be simpler thereby reducing cost but resulting in longer transition time and increased oscillation with respect to DC link voltage.

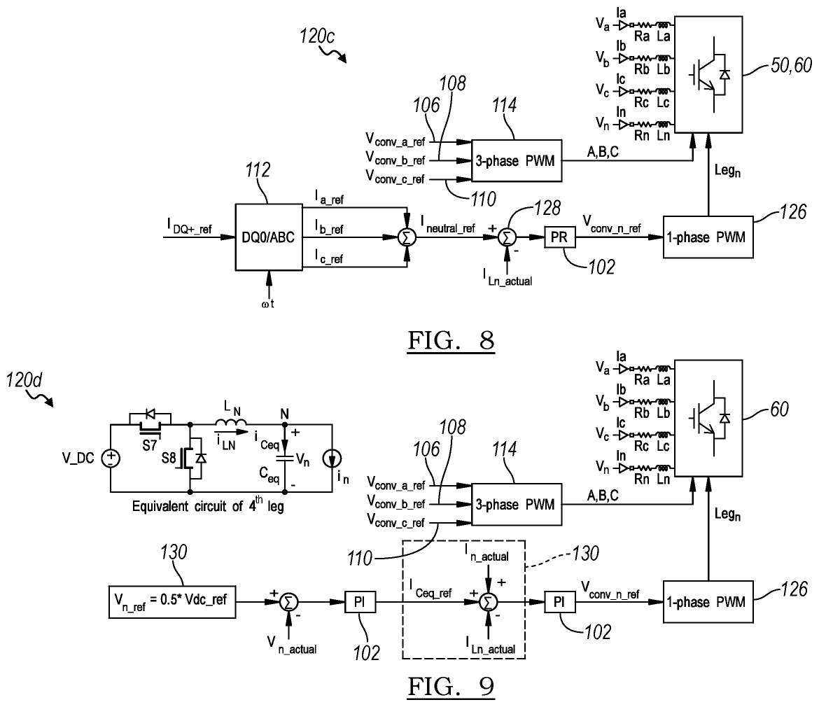

An implementation of a dependent neutral current control system 120c is shown in FIG. 8. The inverse Park-Clark transformation 112 can receive an IDQ+ current reference value and convert the IDQ+ current reference value into an A, B, C reference frame yielding individual current reference values for first leg (A), second leg (B), and third leg (C). The current reference values can be input into a summer 128 to determine a current reference for the neutral leg 44. A PR controller 102 can then provide the current reference for the neutral leg to the one-phase PWM module 126.

An implementation of an independent mid-point voltage control system 120d is shown in FIG. 9. In this control system 120d, a voltage reference signal for the neutral leg 44 can be divided in half by a voltage divider 130. An inner current control loop 132 can be added to improve transitional performance.

It is to be understood that the foregoing is a description of one or more embodiments of the invention. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. All such other embodiments, changes, and modifications are intended to come within the scope of the appended claims.

As used in this specification and claims, the terms “e.g.,” “for example,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation.

What is claimed is:

1. A switching circuit for an electric vehicle (EV), comprising:
a first leg of the switching circuit, including a first switch and a second switch, that receives a first phase of three-phase alternating current (AC) electrical power;
a second leg of the switching circuit, including a first switch and a second switch, that receives a second phase of three-phase AC electrical power;
a third leg of the switching circuit, including a first switch and a second switch, that receives a third phase of three-phase AC electrical power; and
a capacitor leg having two or more capacitors electrically connected in parallel with the first leg, the second leg, the third leg of the switching circuit, wherein the capacitor(s) permit zero sequence current flow through the first leg, the second leg, and the third leg while the three-phase AC electrical power is applied to the circuit.

2. The switching circuit recited in claim 1, further comprising an on-board vehicle battery charger.

3. The switching circuit recited in claim 2, wherein the switching circuit is included in a power-factor correction (PFC) stage of the on-board vehicle battery charger.

4. The switching circuit recited in claim 1, wherein the first leg of the switching circuit, the second leg of the switching circuit, the third leg of the switching circuit, and capacitor(s) rectify AC electrical power into DC electrical power.

5. The switching circuit recited in claim 1, wherein the first leg of the switching circuit, the second leg of the switching circuit, the third leg of the switching circuit, and capacitor(s) invert DC electrical power into AC electrical power.

6. The switching circuit recited in claim 5, wherein the DC electrical power is stored in a vehicle battery.

7. A switching circuit for an electric vehicle (EV), comprising:
a first leg of the switching circuit, including a first switch and a second switch, that receives a first phase of three-phase alternating current (AC) electrical power;
a second leg of the switching circuit, including a first switch and a second switch, that receives a second phase of three-phase AC electrical power;
a third leg of the switching circuit, including a first switch and a second switch, that receives a third phase of three-phase AC electrical power;
a neutral leg including a first switch and a second switch, that permit zero sequence current flow through the first leg, the second leg, and the third leg while the three-phase AC electrical power is applied to the circuit; and
a capacitor leg having one or more capacitors electrically connected in parallel with the first leg, the second leg, the third leg of the switching circuit.

8. The switching circuit recited in claim 7, further comprising an on-board vehicle battery charger.

9. The switching circuit recited in claim 8, wherein the switching circuit is included in a power-factor correction (PFC) stage of the on-board vehicle battery charger.

10. The switching circuit recited in claim 7, wherein the first leg of the switching circuit, the second leg of the switching circuit, the third leg of the switching circuit, and the neutral leg rectify AC electrical power into DC electrical power.

11. The switching circuit recited in claim 7, wherein the first leg of the switching circuit, the second leg of the switching circuit, the third leg of the switching circuit, and the neutral leg invert DC electrical power into AC electrical power.

12. The switching circuit recited in claim 11, wherein the DC electrical power is stored in a vehicle battery.

13. The switching circuit recited in claim 7, further comprising an inductor electrically connected to the neutral leg

14. A switching circuit for an electric vehicle (EV), comprising:
a first leg of the switching circuit, including a first switch and a second switch, that receives a first phase of three-phase alternating current (AC) electrical power;
a second leg of the switching circuit, including a first switch and a second switch, that receives a second phase of three-phase AC electrical power;
a third leg of the switching circuit, including a first switch and a second switch, that receives a third phase of three-phase AC electrical power;
a neutral leg including a first switch and a second switch; and
a capacitor leg including two or more capacitors electrically connected to the first leg, the second leg, the third leg, and the neutral leg of the switching circuit in series and electrically connected at a midpoint to the neutral leg, wherein the capacitors permit zero sequence current flow through the first leg, the second leg, or the third leg while the three-phase AC electrical power is applied to the circuit.

15. The switching circuit recited in claim 14, further comprising an on-board vehicle battery charger.

16. The switching circuit recited in claim 14, wherein the first leg of the switching circuit, the second leg of the switching circuit, the third leg of the switching circuit, the neutral leg, and the capacitors rectify AC electrical power into DC electrical power.

17. The switching circuit recited in claim 14, wherein the first leg of the switching circuit, the second leg of the switching circuit, the third leg of the switching circuit, the neutral leg, and the capacitors invert DC electrical power into AC electrical power.

18. The switching circuit recited in claim 14, wherein the DC electrical power is stored in a vehicle battery.

19. The switching circuit recited in claim 14, further comprising an inductor electrically connected to the neutral leg.
